(19) United States
(12) Patent Application Publication
(10) Pub. No.: US 2026/0166902 A1
(43) Pub. Date: Jun. 18, 2026

(54) PRINTING APPARATUS AND PRINTING METHOD

(71) Applicant: CANON KABUSHIKI KAISHA, Tokyo (JP)

(72) Inventors: TAKAAKI SHIMA, Tokyo (JP); NOBORU KUNIMINE, Tokyo (JP); TAKAYUKI USHIYAMA, Chiba (JP)

(21) Appl. No.: 19/411,676

(22) Filed: Dec. 8, 2025

(30) Foreign Application Priority Data
Dec. 17, 2024 (JP) 2024-220850

(51) Int. Cl. B41J 29/393; B41J 11/00

(52) U.S. Cl. CPC B41J 29/393; B41J 11/0022

(57) ABSTRACT

The present disclosure is directed to shortening the time required before starting printing after accepting a print instruction. A printing apparatus includes: a heating device disposed on a path along which a print medium is conveyed by a conveyance unit, and configured to heat a liquid applied to the print medium; an obtaining unit configured to obtain a permission temperature at which printing on the print medium is permitted to start from a storage device storing information indicating the permission temperature; and a printing control unit configured to control a printing unit configured to perform printing on the print medium. The permission temperature is set below a target temperature specified to fix the liquid applied to the print medium to the print medium. The printing control unit causes the printing unit to start printing in a case where a temperature of the heating device reaches the permission temperature (FIG. 6).

### BACKGROUND

### Field of the Technology

The present disclosure relates to an inkjet image printing apparatus.

### Description of the Related Art

Japanese Patent Laid-Open No. H06-301255 discloses an image forming apparatus that shortens the time required before starting printing. This image forming apparatus measures the surface temperature of a heating roller serving as a heating device with a sensor and calculates the rate of rise in the measured surface temperature to predict the time at which the surface temperature reaches a printing temperature. Also, this image forming apparatus feeds a print medium such that the print medium will be conveyed at the predetermined reaching time.

### SUMMARY

For printing apparatuses, the time required before starting printing after accepting a print instruction may be one important aspect for the user. Thus, there is a demand to shorten the time required before starting printing after accepting a print instruction.

A printing apparatus according an aspect of the present disclosure includes a conveyance unit configured to convey a print medium; a heating device disposed on a path along which the print medium is conveyed by the conveyance unit, and configured to heat a liquid applied to the print medium; a printing unit configured to perform printing on the print medium; one or more memories; and one or more processors configured to function to obtain a permission temperature being a temperature at which printing on the print medium is permitted to start from a storage device storing information indicating the permission temperature, and control the printing unit such that the printing unit starts printing on the print medium in a case where a temperature of the heating device reaches the permission temperature. The permission temperature is set to be lower than a target temperature specified to fix the liquid applied to the print medium to the print medium.

Features of the present disclosure will become apparent from the following description of embodiments with reference to the attached drawings. The following description of embodiments are described by way of example.

### BRIEF DESCRIPTION OF THE DRAWINGS

FIG. 1A is a perspective view illustrating an example of an outer configuration of an inkjet printing apparatus, and FIG. 1B is a schematic view illustrating part of the inkjet printing apparatus;

FIG. 2 is a block diagram illustrating an example of a configuration of the inkjet printing apparatus;

FIG. 3 is a view illustrating an example of a configuration of an ejection orifice forming substrate included in a print head;

FIG. 4 is a schematic view illustrating an example of a configuration of ejection orifice arrays;

FIG. 5 is a schematic diagram illustrating an example of printing an image in an 8-pass mode;

FIG. 6 is a flowchart illustrating an example of a series of processes executed in a first embodiment;

FIG. 7 is a graph illustrating an example of temperature change of a heating device in the first embodiment;

FIG. 8 is a graph illustrating another example of the temperature change of the heating device in the first embodiment;

FIG. 9 is a flowchart illustrating an example of a series of processes executed in a second embodiment;

FIG. 10 is a graph illustrating an example of temperature change of a heating device in the second embodiment;

FIG. 11 is a flowchart illustrating an example of a series of processes executed in a third embodiment;

FIG. 12 is a graph illustrating an example of temperature change of a heating device in the third embodiment;

FIG. 13 is a flowchart illustrating an example of a series of processes executed in a fourth embodiment; and

FIG. 14 is a graph illustrating an example of temperature change of a heating device in the fourth embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

### <Overview>

A printing apparatus is known in which, after inks are applied to a print medium, the print medium is conveyed to a heating device, and the ink applied to the print medium are fixed through heating by the heating device. This printing apparatus requires a warm-up time before the temperature of the heating device reaches a temperature at which the inks can be fixed. In a case where the conveyance of the print medium to the heating device is started after the heating device reaches the temperature at which the inks can be fixed, there will be a considerable time between when the printing apparatus receives a print instruction and the start of the printing. In the following, an example of shortening the time required before starting printing after accepting a print instruction will be described with reference to drawings. In drawings to be referred to, X and Y directions are defined. The X and Y directions are orthogonal to each another.

### <Apparatus Configuration>

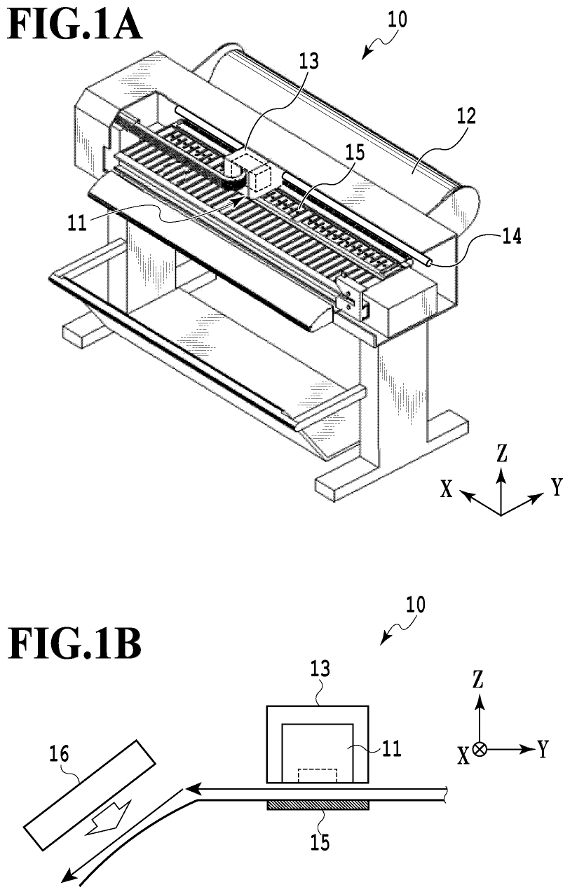

FIG. 1A is a perspective view illustrating an example of an outer configuration of an inkjet printing apparatus 10 in the present embodiment. In FIG. 1A, some elements of the inkjet printing apparatus 10 are omitted in order to describe its internal mechanisms. The inkjet printing apparatus 10 is an apparatus that performs printing on a print medium 12 by ejecting liquids from a print head 11 while scanning it. In the example of FIG. 1, the print medium 12 is rolled paper. The inkjet printing apparatus 10 prints (forms) an image on the print medium 12 by repeating a printing operation and a conveyance operation. The printing operation is an operation of ejecting the liquids from the print head 11 while scanning it in a main scanning direction. The conveyance operation is an operation of conveying the print medium 12 in a sub scanning direction. The main scanning direction and the sub scanning direction intersect each other. In the example of FIGS. 1A and 1i, the main scanning direction is the +X direction or −X direction, and the sub scanning direction is the −Y direction.

The print head 11 is mounted on a carriage 13. The carriage 13 is attached to a guide shaft 14 in such a way as to be movable along the guide shaft 14. The guide shaft 14 is disposed along the main scanning direction. The print head 11 mounted on the carriage 13 is reciprocally movable in the main scanning direction along the guide shaft 14.

In the present embodiment, a bidirectional printing method is employed as the method of performing printing on the print medium 12. The bidirectional printing method is a method in which printing is performed on the print medium 12 by ejecting the liquids from the print head 11 during both the movement of the print head 11 along a forward path and the movement of the print head 11 along a backward path. The print medium 12 is conveyed by a predetermined amount in response to one or more scans of the print head 11 involving liquid ejection. The liquids to be ejected from the print head 11 include at least inks. In the present embodiment, the liquids to be ejected from the print head 11 include inks containing color materials and a reaction liquid containing a reactant that reacts with the color materials.

FIG. 1B is a schematic view illustrating part of the inkjet printing apparatus 10. The straight black arrows in FIG. 1B indicate the conveyance direction of the print medium. In the inkjet printing apparatus 10, in a case where a print command is input, the first unit region of the print medium 12 is conveyed to a printing part. This printing part is an ejection part at which the inks and the reaction liquid are ejected. This ejection part is located between a platen 15 which is a member supporting the print medium 12 and the print head 11 mounted on the carriage 13. After the first unit region of the print medium 12 is conveyed to the printing part, a printing operation and a conveyance operation over the predetermined amount are alternately repeated based on a print signal. As a result, the inks and the reaction liquid ejected during each scan are applied to the corresponding unit region of the print medium 12, so that an image based on the print signal is printed (formed) on the print medium 12. Further, at the printing part, the print medium 12 to which the inks and the reaction liquid have been applied is conveyed in the −Y direction. A heating device 16 is disposed on the conveyance path for the print medium 12. The heating device 16 is located downstream of the printing part (or print head 11) in the conveyance direction of the print medium 12. This heating device 16 heats the inks and the reaction liquid applied to the print medium 12. The color materials and the like in the inks get fixed to the print medium 12 by this heating. Note that a target temperature is set to heat and fix the liquids applied to the print medium 12.

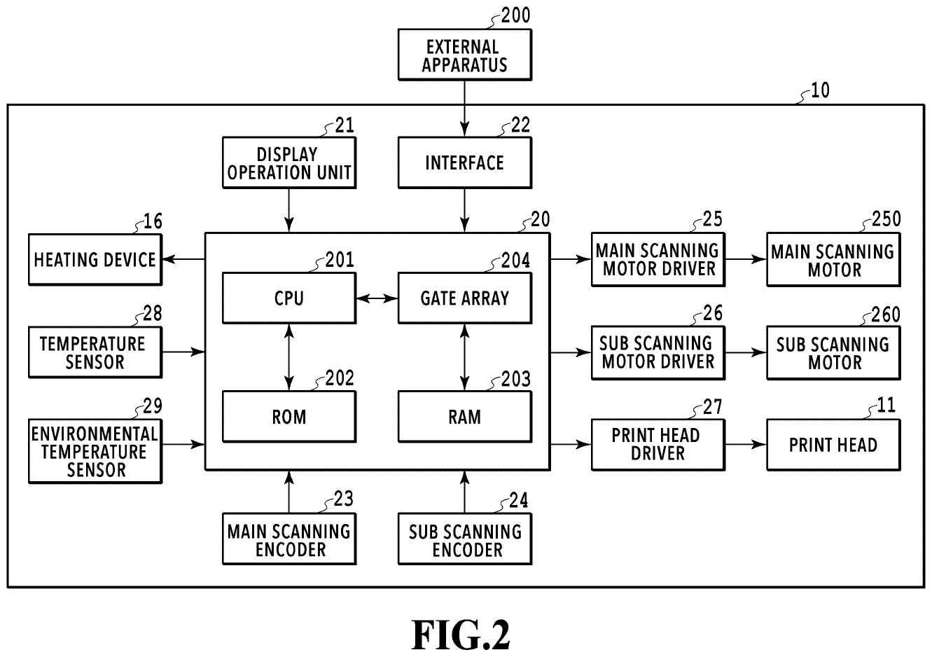

FIG. 2 is a block diagram illustrating an example of a configuration of the inkjet printing apparatus 10. The inkjet printing apparatus 10 includes a control unit 20. The control unit 20 controls the inkjet printing apparatus 10.

The heating device 16 is connected to the control unit 20. The heating device 16 is a heater that generates heat for fixing the inks and the reaction liquid applied to the print medium 12 to the print medium 12. In the present embodiment, the heating device 16 is, but not limited to, a fan capable of sending warm air. The heating device 16 heats the print medium 12 at a set temperature. The temperature of the heating device 16 is set by the control unit 20. The control unit 20 is capable of adjusting the heat quantity (amount of heating) of the heating device 16 by controlling the temperature setting of the heating device 16.

A display operation unit 21 is connected to the control unit 20. The display operation unit 21 is capable of displaying things based on information. Also, the display operation unit 21 is capable of receiving information based on user operations. For example, the display operation unit 21 receives information indicating printing conditions designated by the user, such as a standard setting for the amount of the reaction liquid for printing. The display operation unit 21 includes a display. The display operation unit 21 may include a touch panel.

An interface 22 is connected to the control unit 20. The interface 22 receives data, such as image data, from an external apparatus 200. A main scanning encoder 23 outputs a signal indicating the position of a main scanning motor 250 to the control unit 20. A sub scanning encoder 24 outputs a signal indicating the position of a sub scanning motor 260 to the control unit 20.

A main scanning motor driver 25 and a sub scanning motor driver 26 are connected to the control unit 20. The main scanning motor driver 25 controls the main scanning motor 250 based on a signal supplied from the control unit 20 to scan the print head 11 mounted on the carriage 13. The sub scanning motor driver 26 controls the sub scanning motor 260 based on a signal supplied from the control unit 20 to convey the print medium 12. A print head driver 27 controls the print head 11 based on a signal supplied from the control unit 20 to eject the inks and the reaction liquid.

A temperature sensor 28 is connected to the control unit 20. The temperature sensor 28 is a sensor that measures the temperature of the heating device 16. The temperature of the heating device 16 to be detected by the temperature sensor 28 may be the temperature of a heat path inside the heating device 16. Alternatively, the temperature of the heating device 16 to be detected by the temperature sensor 28 may be the temperature of the heat source of the heating device 16. Still alternatively, the temperature of the heating device 16 to be detected by the temperature sensor 28 may be the temperature of air heated by the heating device 16.

An environmental temperature sensor 29 is connected to the control unit 20. The environmental temperature sensor 29 is a sensor that measures a temperature indicating an environment in which the inkjet printing apparatus 10 operates (environmental temperature). The environmental temperature sensor 29 is provided on an outer portion of the inkjet printing apparatus 10 (the surface of its housing) or the like, for example. The environmental temperature sensor 29 may be omitted except in the fourth embodiment to be described later. In this case, the environmental temperature sensor 29 is not connected to the control unit 20.

The control unit 20 includes a central processing unit (CPU) 201, a read-only memory (ROM) 202, and a random-access memory (RAM) 203. The CPU 201 is a processor (calculation unit) that controls the operation of the inkjet printing apparatus 10. The CPU 201 executes various processes by executing programs or activating hardware. The ROM 202 stores various pieces of data. For example, the ROM 202 stores programs to be executed by the CPU 201 and data required for the operation of the inkjet printing apparatus 10. The RAM 203 is used as a work area for the CPU 201. The RAM 203 is also used as an area to temporarily store data. For example, the RAM 203 temporarily stores image data to be used to control the inkjet printing apparatus 10, print signals to be supplied to the print head 11, and so on.

The control unit 20 includes a gate array 204. The gate array 204 supplies control signals to the main scanning motor driver 25, the sub scanning motor driver 26, and the print head driver 27. Also, the gate array 204 transfers various signals between itself and the CPU 201, the RAM 203, and the interface 22. Also, the gate array 204 performs processing along with the CPU 201. For example, the gate array 204 converts image data supplied from the external apparatus 200 through the interface 22 into a print signal which the inkjet printing apparatus 10 can handle. The print signal is a signal for forming (printing) an image on the print medium 12.

The CPU 201 executes a print control process based on the print signal. The print control process is a control process for printing the image based on the print signal on the print medium 12. This print control process includes controlling the main scanning motor driver 25 to scan the print head 11 (main scanning). Also, this print control process includes controlling the sub scanning motor driver 26 to convey the print medium 12. Also, this print control process includes controlling the print head driver 27 to eject the inks and the reaction liquid from the print head 11. Also, this print control process includes driving the main scanning motor driver 25, the sub scanning motor driver 26, and the print head driver 27 in synchronization with one another. Also, this print control process includes controlling the heating device 16 to adjust the temperature of the heating device 16. By causing the CPU 201 to execute the print control process based on the print signal, an image is printed (formed) on the print medium 12.

### <Head Configuration>

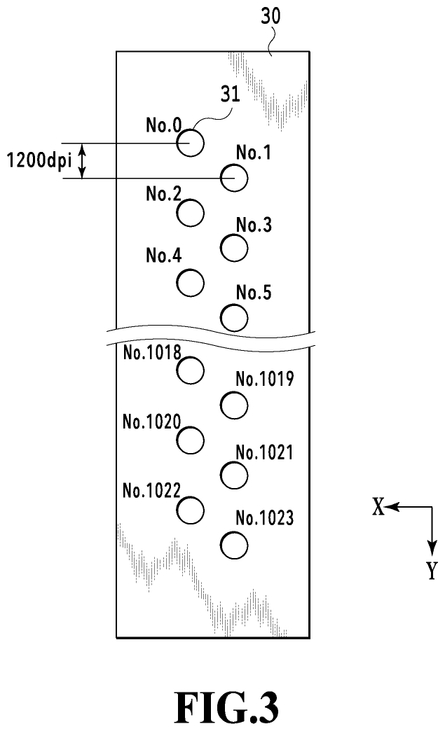

FIG. 3 is a view illustrating an example of a configuration of an ejection orifice forming substrate 30 included in the print head 11 from the ejection orifice side. In the print head 11, an ejection orifice array is formed per color. For example, the ejection orifice array includes 1024 ejection orifices 31 arrayed in the Y direction at a density of 1200 ejection orifices per inch. The array direction of the ejection orifices 31 runs along the sub scanning direction. In the present embodiment, the print head 11 is capable of ejecting droplets at a driving frequency of 21 kHz at maximum. Each single droplet ejected from each ejection orifice 31 is approximately 4 ng.

The inkjet printing apparatus 10 in the present embodiment ejects the inks and the reaction liquid from the print head 11. Specifically, a black ink, a cyan ink, a magenta ink, a yellow ink, and a reaction liquid are ejected from the print head 11. Here, the reaction liquid acts as an image printing aid by reacting with solid components contained in the inks such as their color materials and resin particles via contact with the inks to promote their coagulation. Specific details of the inks and the reaction liquid will be described later.

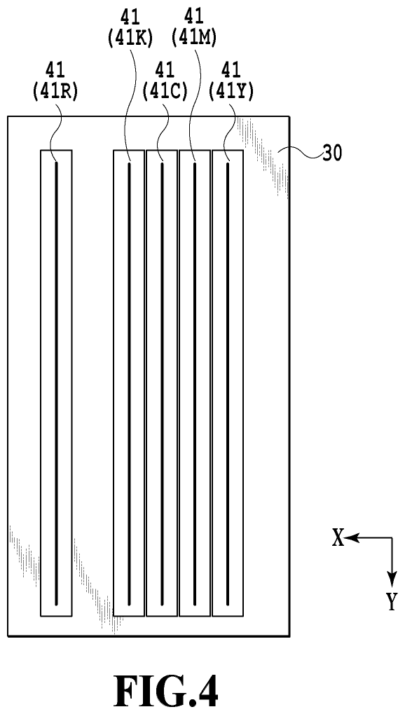

FIG. 4 is a schematic view illustrating an example of a configuration of ejection orifice arrays 41. Five ejection orifice arrays 41 are formed in the ejection orifice forming substrate 30. In the example of FIG. 4, a black ejection orifice array 41K is formed as an ejection orifice array 41 for the black ink. Also, a cyan ejection orifice array 41C is formed as an ejection orifice array 41 for the cyan ink. Also, a magenta ejection orifice array 41M is formed as an ejection orifice array 41 for the magenta ink. Also, a yellow ejection orifice array 41Y is formed as an ejection orifice array 41 for the yellow ink. Also, a reaction liquid ejection orifice array 41R is formed as an ejection orifice array 41 for the reaction liquid.

### <Ink Compositions>

Next, the compositions of the inks used in the present embodiment will be described. In the following, “part” and “%” are based on mass, unless otherwise noted. The inks used in the present embodiment each contain a pigment, resin particles, and a water-soluble organic solvent. As mentioned above, the inks in the present embodiment are a black ink, a cyan ink, a magenta ink, and a yellow ink. Black-, cyan-, magenta-, and yellow-based pigments are used as the pigments for the color materials of the inks. In the following, these inks may be collectively referred to as “color inks.”

The water-soluble organic solvent in the present embodiment will now be described. The water-soluble organic solvent may be one with a boiling point of 150° C. or more and 3000 or less in view of the wettability and moisture retentiveness of the ejection orifice surface of the head. Also, from the viewpoint of the function of a film formation aid for the resin particles and the swelling and dissolution into the print medium on which a resin layer is formed, the water-soluble organic solvent may be the following: a ketone-based compound such as acetone or cyclohexanone; a propylene glycol derivative such as tetraethylene glycol dimethyl ether; or a heterocyclic compound having a lactam structure as represented by N-methyl-pyrrolidone or 2-pyrrolidone. From the viewpoint of ejection performance, the content of the water-soluble organic solvent may be 3% by mass or more and 30% by mass or less relative to the total mass of the ink. The water-soluble organic solvent may be any of alkyl alcohols having one to four carbon atoms. Specific examples include methyl alcohol, ethyl alcohol, n-propyl alcohol, isopropyl alcohol, n-butyl alcohol, sec-butyl alcohol, tert-butyl alcohol, and the like. Alternatively, the water-soluble organic solvent may be any of amides such as dimethylformamide and dimethylacetamide. Alternatively, the water-soluble organic solvent may be any of ketones or keto-alcohols such as acetone and diacetone alcohol. Alternatively, the water-soluble organic solvent may be any of ethers such as tetrahydrofuran and dioxane. Alternatively, the water-soluble organic solvent may be any of polyalkylene glycols such as polyethylene glycol and polypropylene glycol. Alternatively, the water-soluble organic solvent may be ethylene glycol. Alternatively, the water-soluble organic solvent may be any of alkylene glycols with an alkylene group having two to six carbon atoms. Specific examples include propylene glycol, butylene glycol, triethylene glycol, 1,2,6-hexane triol, thiodiglycol, he xylene glycol, diethylene glycol, and the like. Alternatively, the water-soluble organic solvent may be lower alkyl ether acetates such as polyethylene glycol monomethyl ether acetate or the like. Alternatively, the water-soluble organic solvent may be glycerin. Alternatively, the water-soluble organic solvent may be a lower alkyl ether of a polyalcohol. Specific examples include ethylene glycol monomethyl (or ethyl) ether, diethylene glycol methyl (or ethyl) ether, triethylene glycol monomethyl (or ethyl) ether, and the like. Alternatively, the water-soluble organic solvent may be a polyalcohol such as trimethylolpropane or trimethylolethane. Alternatively, the water-soluble organic solvent may be N-methyl-2-pyrrolidone, 2-pyrrolidone, or 1,3-dimethyl-2-imidazolidinone. Water-soluble organic solvents as listed above can be used alone or as a mixture. Also, pure water (deionized water) may be used as the water. Besides the above components, a surfactant, a defoamer, a preservative, a mildewproofing agent, and the like may be added as appropriate in order to impart desired physical properties as necessary.

The resin particles in the present embodiment will now be described. The inks in the present embodiment each contain resin particles intended to allow tight contact between the print medium and the color material to improve the scratch resistance (fixability) of the printed image. The resin particles melt with heat, and the heating device (heater) is used to form the resin particles into a film and dry the solvent contained in the ink. In the present embodiment, “resin particles” mean a resin that is dispersible in an aqueous medium, and a resin that is soluble to an aqueous medium is a water-soluble resin. Specifically, the resin particles may be particles of an acrylic resin synthesized by emulsion polymerization or the like of a monomer of a (meth)acrylic acid alkyl ester, a (meth)acrylic acid alkyl amide, or the like. Alternatively, the resin particles may be particles of a styrene-acrylic resin synthesized by emulsion polymerization or the like of monomers of a (meth)acrylic acid alkyl ester, a (meth)acrylic acid alkyl amide, or the like and styrene. Alternatively, the resin particles may be particles of a polyethylene resin, particles of a polypropylene resin, particles of a polyurethane resin, or particles of a styrene-butadiene resin. Also, the resin particles may be core-shell type resin particles each formed of a core portion and a shell portion differing from each other in resin composition. Alternatively, the resin particles may be resin particles obtained by preparing fine acrylic particles as seed particles synthesized in advance in order to control the particle size and then allowing emulsion polymerization around the fine acrylic particles. Alternatively, the resin particles may be hybrid resin particles obtained by chemically binding different types of resin particles, such as acrylic resin particles and urethane resin particles. Also, the resin particles may be in the form of resin particles obtained by homopolymerizing a monomer having a dissociable group alone or by copolymerizing a plurality of kinds thereof, or so-called self-dispersing resin particles. Here, the dissociable group may be a carboxyl group, a sulfonic acid group, a phosphoric acid group, or the like. Monomers having these dissociable groups may be acrylic acid, methacrylic acid, and the like. Further, the resin particles may be so-called emulsion dispersion-type resin particles in which resin particles are dispersed using an emulsifier. As the emulsifier, materials having anionic charges may be used regardless of whether the molecular weight is low or high.

### <Reaction Liquid Composition>

Next, the reaction liquid in the present embodiment will be described. The reaction liquid reacts with each ink via contact with the ink, causing coagulation of components in the ink (resins, a surfactant, and components having anionic groups, such as a self-dispersing pigment) and contains a reactant. Here, the reactant is a component that, in a case of being blended with the ink on the print medium or the like, lowers the dispersion stability of the ink, that is, destabilizes the state of presence of the components having anionic groups, to promote coagulation of the ink. The reactant may be a polyvalent metal ion, a cationic component such as a cationic resin, an organic acid, or the like.

### <Preparation Methods>

Next, methods of preparing the inks and the reaction liquid will be described. Note that “parts” and “%” described regarding the amounts of components are based on mass unless otherwise noted.

### <<Preparation of Resin Particles>>

An aqueous dispersion liquid with resin particles to be used in the present embodiment are prepared as below. First, under a nitrogen atmosphere, the following emulsified product heated to 70° C. is added by dripping it little by little while agitating it, and polymerized for 5 hours. Thereafter, the resulting product is cooled down to 25° C., followed by adding deionized water and an aqueous potassium hydroxide solution in appropriate amounts. As a result, an aqueous dispersion liquid with resin particles with a resin particle content of 20.0% is prepared. As the emulsified product, a mixture obtained by blending 28.5 parts of methyl methacrylate, 4.3 parts of sodium p-styrenesulfonate, and 0.05 part of potassium persulfate in 30.0 parts of water is used.

### <<Black Ink>>

### (1) Preparation of Dispersion Liquid

Firstly, styrene/butyl acrylate/acrylic acid copolymer (polymerization ratio (weight ratio)=30/40/30, acid value=202, weight average molecular weight=6500) is prepared as a resin (resin dispersant). 10.0 parts of the resin is neutralized with potassium hydroxide equimolar to the acid value of the resin, and an appropriate amount of water is added to prepare an aqueous solution of a resin 1 having a resin content of 10.0%, 60.0 parts of the resin 1 aqueous solution, 10.0 parts of carbon black, and 30.0 parts of pure water are blended to obtain a mixture. The obtained mixture is mechanically agitated for a predetermined time, followed by a centrifugation process to remove non-dispersive substances including coarse particles. Then, pressurized filtering is performed through a cellulose acetate filter with a pore size of 3.0 m (manufactured by ADVANTEC CO., LTD.). As a result, a black pigment dispersion liquid with a pigment content of 10.0% is prepared.

### (2) Preparation of Ink

The following components are blended and sufficiently agitated, and then subjected to pressurized filtering through a micro-filter with a pore size of 2.5 m (manufactured by FUJIFILM Corporation) to prepare a pigment ink with a pigment concentration of 2.0%. Note that deionized water is added such that the ink's components will be 100.0 parts in total.

| | | |
|---|---|---|
| Black pigment dispersion liquid | 20.0 | parts |
| Resin particle aqueous dispersion liquid | 40.0 | parts |
| Zonyl FSO-100 (a fluorine-based surfactant | 0.05 | part |
| manufactured by DuPont) | | |
| 2-methyl 1,3 propanediol | 15.0 | parts |
| 2-pyrrolidone | 5.0 | parts |
| ACETYLENOL E100 (manufactured by Kawaken Fine | 0.5 | part |
| Chemicals Co., Ltd.) | | |

| | |
|---|---|
| Deionized water | balance |

### <<Cyan Ink>>

### (1) Preparation of Dispersion Liquid

First, using benzyl acrylate and methacrylic acid as raw materials, an AB block polymer having an acid value of 250 and a number average molecular weight of 3000 is made in a usual manner. Then, 50.0 parts of the resin is neutralized with potassium hydroxide equimolar to the acid value of the resin, and an appropriate amount of water is added to prepare an aqueous solution of a resin 2 having a resin content of 50.0%, 20.0 parts of the resin 2 aqueous solution, 10.0 parts of C.I Pigment Blue 15:3, and 70.0 parts of pure water are blended to obtain a mixture. The obtained mixture is mechanically agitated for a predetermined time, followed by a centrifugation process to remove non-dispersive substances including coarse particles. Then, pressurized filtering is performed through a cellulose acetate filter with a pore size of 3.0 μm (manufactured by ADVANTEC CO., LTD.). As a result, a cyan pigment dispersion liquid with a pigment content of 10.0% is prepared.

### (2) Preparation of Ink

The following components are blended and sufficiently agitated, and then subjected to pressurized filtering through a micro-filter with a pore size of 2.5 m (manufactured by FUJIFILM Corporation) to prepare a pigment ink with a pigment concentration of 2.0%. Note that deionized water is added such that the ink's components will be 100.0 parts in total.

| | | |
|---|---|---|
| Cyan pigment dispersion liquid | 20.0 | parts |
| Resin particle aqueous dispersion liquid | 40.0 | parts |
| Zonyl FSO-100 (a fluorine-based surfactant | 0.05 | part |
| manufactured by DuPont) | | |
| 2-methyl 1,3 propanediol | 15.0 | parts |
| 2-pyrrolidone | 5.0 | parts |
| ACETYLENOL E100 (manufactured by Kawaken | 0.5 | part |
| Fine Chemicals Co., Ltd.) | | |

| | |
|---|---|
| Deionized water | balance |

### <<Magenta Ink>>

### (1) Preparation of Dispersion Liquid

First, using benzyl acrylate and methacrylic acid as raw materials, an AB block polymer having an acid value of 300 and a number average molecular weight of 2500 is made in a usual manner. Then, 50.0 parts of the resin is neutralized with potassium hydroxide equimolar to the acid value of the resin, and an appropriate amount of water is added to prepare an aqueous solution of a resin 3 having a resin content of 50.0%, 10.0 parts of the resin 3 aqueous solution, 10.0 parts of C.I. Pigment Red 122, and 80.0 parts of deionized water are blended to obtain a mixture. The obtained mixture is mechanically agitated for a predetermined time, followed by a centrifugation process to remove non-dispersive substances including coarse particles. Then, pressurized filtering is performed through a cellulose acetate filter with a pore size of 3.0 m (manufactured by ADVANTEC CO., LTD.). As a result, a magenta pigment dispersion liquid with a pigment content of 10.0% is prepared.

### (2) Preparation of Ink

The following components are blended and sufficiently agitated, and then subjected to pressurized filtering through a micro-filter with a pore size of 2.5 m (manufactured by FUJIFILM Corporation) to prepare a pigment ink with a pigment concentration of 3.0%. Note that deionized water is added such that the ink's components will be 100.0 parts in total.

| | | |
|---|---|---|
| Magenta pigment dispersion liquid | 30.0 | parts |
| Resin particle aqueous dispersion liquid | 40.0 | parts |
| Zonyl FSO-100 (a fluorine-based surfactant | 0.05 | part |
| manufactured by DuPont) | | |
| 2-methyl 1,3 propanediol | 15.0 | parts |
| 2-pyrrolidone | 5.0 | parts |
| ACETYLENOL E100 (manufactured by Kawaken | 0.5 | part |
| Fine Chemicals Co., Ltd.) | | |

| | |
|---|---|
| Deionized water | balance |

### <<Yellow Ink>>

### (1) Preparation of Dispersion Liquid

30.0 parts of the resin 1 aqueous solution, 10.0 parts of C.I. Pigment Yellow 74, and 60.0 parts of deionized water are blended to obtain a mixture. The obtained mixture is mechanically agitated for a predetermined time, followed by a centrifugation process to remove non-dispersive substances including coarse particles. Then, pressurized filtering is performed through a cellulose acetate filter with a pore size of 3.0 m (manufactured by ADVANTEC CO., LTD.). As a result, a yellow pigment dispersion liquid with a pigment content of 10.0% is prepared.

### (2) Preparation of Ink

The following components are blended and sufficiently agitated, and then subjected to pressurized filtering through a micro-filter with a pore size of 1.0 m (manufactured by FUJIFILM Corporation) to prepare a pigment ink with a pigment concentration of 3.0%. Note that deionized water is added such that the ink's components will be 100.0 parts in total.

| | | |
|---|---|---|
| Yellow pigment dispersion liquid | 30.0 | parts |
| Resin particle aqueous dispersion liquid | 40.0 | parts |
| Zonyl FSO-100 (a fluorine-based surfactant | 0.025 | part |
| manufactured by DuPont) | | |
| 2-methyl 1,3 propanediol | 15.0 | parts |
| 2-pyrrolidone | 5.0 | parts |
| ACETYLENOL E100 (manufactured by Kawaken | 1.0 | part |
| Fine Chemicals Co., Ltd.) | | |

| | |
|---|---|
| Deionized water | balance |

### <<Reaction Liquid>>

The following components are blended to prepare a reaction liquid. This reaction liquid contains magnesium sulfate as a reactant. Note that deionized water is added such that the reaction liquid's components will be 100.0 parts in total.

| | | |
|---|---|---|
| Magnesium sulfate heptahydrate | 4.1 | parts |
| 2-pyrrolidone | 5.0 | parts |
| 2-methyl 1,3 propanediol | 15.0 | parts |
| ACETYLENOL E100 (manufactured by Kawaken | 0.5 | part |
| Fine Chemicals Co., Ltd.) | | |

| | |
|---|---|
| Deionized water | balance |

### <Multi-Pass Printing>

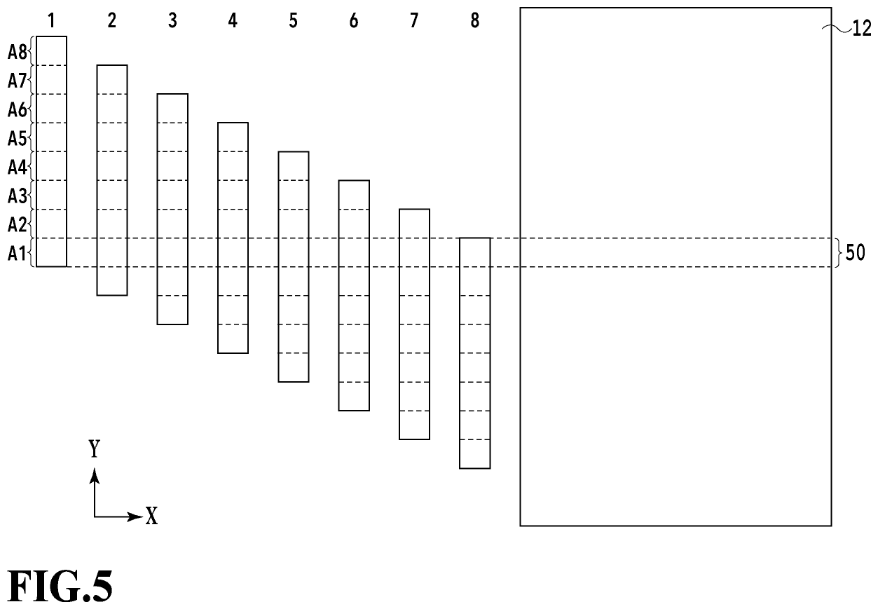

In the present embodiment, a multi-pass printing method is employed in which a plurality of scans are performed to print an image on a unit region of the print medium 12. Multi-pass printing is employed for the purpose of avoiding or reducing unevenness and streaks or for the purpose of increasing the amounts of the inks and the reaction liquid to be applied. In each of the plurality of scans, the color inks and the reaction liquid are ejected in accordance with a print signal specifying, for each of the inks and the reaction liquid, whether or not to eject it for each of the plurality of pixels. FIG. 5 is a schematic diagram illustrating an example of printing an image in an 8-pass mode. In the 8-pass mode, printing on a unit region 50 of the print medium 12 is completed by performing eight scans.

In FIG. 5, eight ejection orifice groups A1 to A8 are illustrated. Though not illustrated, each of the eight ejection orifice groups A1 to A8 is formed by dividing a plurality of ejection orifice arrays in the Y direction. The plurality of ejection orifice arrays are the black ejection orifice array 41K (FIG. 4), the cyan ejection orifice array 41C (FIG. 4), the magenta ejection orifice array 41M (FIG. 4), the yellow ejection orifice array 41Y (FIG. 4), and the reaction liquid ejection orifice array 41R (FIG. 4). To simplify the description, in FIG. 5, the print head 11 is moved in the +Y direction between scans of the print head 11. In reality, however, the print medium 12 is moved in the −Y direction between scans of the print head 11.

First, in the first scan (first pass), the unit region 50 of the print medium 12 and the ejection orifice group A1 are in such a positional relationship as to face each other. In this positional relationship, the print head 11 ejects the inks and the reaction liquid from the ejection orifice group A1 onto the unit region 50 in accordance with the print signal corresponding to the first scan while being scanned in the X direction to perform printing for the first pass. After the printing for the first pass is finished, the print medium 12 is conveyed in the −Y direction by a distance corresponding to one ejection orifice group. After this conveyance is finished, the unit region 50 of the print medium 12 and the ejection orifice group A2 are in such a positional relationship as to face each other. In this positional relationship, the second scan (second pass) is started. The print head 11 ejects the inks and the reaction liquid from the ejection orifice group A2 onto the unit region 50 in accordance with the print signal corresponding to the second scan while being scanned in the X direction to perform printing for the second pass. Subsequently, the conveyance of the print medium 12 and the ejection from the print head 11 are alternately performed to perform printing for the third to eighth passes on the unit region 50. The multi-pass printing on the unit region 50 is completed in this manner.

### <Permission Temperature Table>

In the present embodiment, a permission temperature being a temperature at which printing on the print medium 12 is permitted to start (print start permission temperature) is specified in advance in order to shorten the time required before starting printing after accepting a print instruction. A permission temperature table includes permission temperatures associated respectively with a plurality of target temperatures. Each target temperature is a target value of the temperature of the heating device 16 for generating heat with which to fix the inks to the print medium 12. The permission temperature table is stored in the ROM 202. In the permission temperature table, the higher the target temperature is, the higher the permission temperature is set. An example of the permission temperature table is illustrated in Table 1 below.

TABLE 1

| | Target Temperature Setting (° C.) | | |
|---|---|---|---|
| | 70 | 80 | 90 |
| Permission | 55 | 65 | 75 |
| Temperature | | | |
| Tp1 (° C.) | | | |

In the example of Table 1 above, in a case where the target temperature is 70° C., a permission temperature Tp1 is set to 55° C. Also, in a case where the target temperature is 80° C., which is higher than 70° C., the permission temperature Tp1 is set to 65° C., which is higher than 55° C. Also, in a case where the target temperature is 90° C., which is higher than 80° C., the permission temperature Tp1 is set to 75° C., which is higher than 65° C. That is, for example, in a case where the target temperature is 70° C., printing will be started at a timing at which 55° C., or the permission temperature, is reached. In this way, the time required before starting the printing after accepting the print instruction can be shortened.

### <Control Process>

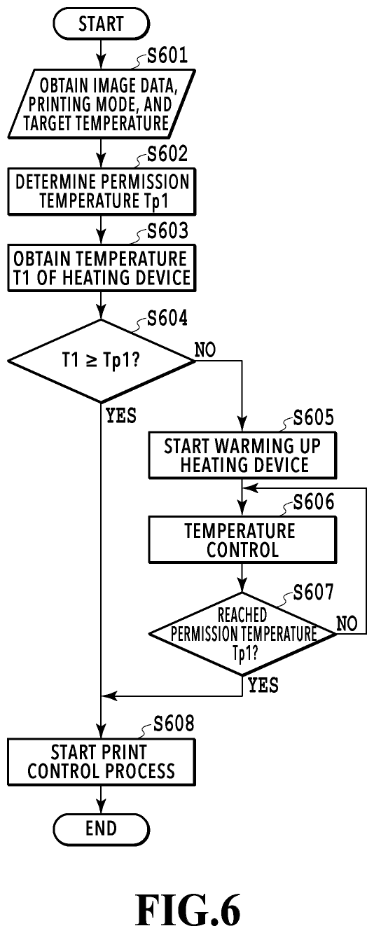

Next, a flow of a control process in the present embodiment will be described. The control process in the present embodiment is a process up to the start of printing after accepting a print command. FIG. 6 is a flowchart illustrating an example of a series of processes (control process) executed in the present embodiment. The CPU 201 (FIG. 2) implements the series of processes (control process) illustrated in FIG. 6 by reading out a program stored in the ROM 202 (FIG. 2) or the like to the RAM 203 (FIG. 2) and executing it. Note that the functions of some or all of the steps in FIG. 6 may be implemented with hardware, such as an application-specific integrated circuit (ASIC) or an electronic circuit. The symbol “S” in the description of each process means a step in the flowchart (the same applies to the other flowcharts this specification).

In the present embodiment, it is assumed that the print medium 12 is a polyvinyl chloride sheet (trade name: “Scotchcal Graphic Film IJ1220-10,” 3M Japan Limited, thickness=130 m). The series of processes (control process) illustrated in FIG. 6 is started in a case where the CPU 201 accepts a print command (print job).

In S601, the CPU 201 obtains image data for printing (forming) an image on the print medium 12, printing mode information indicating a printing mode, and target temperature information indicating the target temperature for the heating device 16. The printing mode information includes the number of passes (the number of scans) to be performed to print an image on a unit region of the print medium 12.

In the present embodiment, the image data, the printing mode information, and the target temperature information are supplied from the external apparatus 200 (FIG. 2) along with the print command, but the present embodiment is not limited to this. For example, at least one of the printing mode information and the target temperature information may be designated (selected) by the user with the display operation unit 21 and supplied from the display operation unit 21 in accordance with that designation (selection). Also, the target temperature may be obtained from a table. For example, in a case where the target temperature varies depending on the number of passes for the printing mode, a target temperature corresponding the number of passes for the printing mode indicated in the printing mode information may be obtained from a table. After obtaining the image data, the printing mode information, and the target temperature information in S601, the processing proceeds to S602.

In S602, the CPU 201 determines the permission temperature Tp1 based on the target temperature information obtained in S601 and the permission temperature table stored in the ROM 202. For example, assuming that the target temperature is set to 70° C. regardless of the printing mode and the permission temperature table is the one illustrated in Table 1, the CPU 201 determines 55° C. to be the permission temperature Tp1. After determining the permission temperature Tp1 in S602, the processing proceeds to S603.

In S603, the CPU 201 obtains a temperature T1 of the heating device 16 using the temperature sensor 28. After obtaining the temperature of the heating device 16 in S603, the processing proceeds to S604.

In S604, the CPU 201 compares the temperature T1 of the heating device 16 obtained in S603 and the permission temperature Tp1 determined in S602 with each other. If a comparison result indicating that the temperature T1 of the heating device 16 is more than or equal to the permission temperature Tp1 is obtained, the processing proceeds to S609. If a comparison result indicating that the temperature T1 of the heating device 16 is less than the permission temperature Tp1 is obtained, the processing proceeds to S605.

In S605, the CPU 201 activates the heating device 16 to start warming up the heating device 16. After activating the heating device 16 in S605, the processing proceeds to S606.

in S606, the CPU 201 starts temperature control on the heating device 16. For example, the CPU 201 decreases the power to be supplied to the heating device 16 the higher the temperature T1 of the heating device 16 becomes. After starting the temperature control on the heating device 16 in S606, the processing proceeds to S607.

In S607, the CPU 201 judges whether the temperature T1 of the heating device 16 has reached the permission temperature Tp1. If the temperature T1 of the heating device 16 has not reached the permission temperature Tp1, the processing returns to S606. If the temperature T1 of the heating device 16 has reached the permission temperature Tp1, the processing proceeds to S608.

In S608, the CPU 201 starts executing a print control process based on a print signal obtained from the image data obtained in S601, thereby causing the inkjet printing apparatus 10 to start a printing operation and a conveyance operation. This starts printing with the inks and the reaction liquid on the print medium 12 disposed at the printing part (ejection part) and also starts conveyance of the print medium 12 to which the inks and the reaction liquid have been applied. Note that, in the case where the processing proceeds to S608 from S607, the temperature control of the heating device 16 is performed from the permission temperature Tp1 in the print control process. On the other hand, in the case where the processing proceeds to S608 from S604, the heating device 16 has already been activated and warmed up. For this reason, in the print control process, the temperature control of the heating device 16 is performed from the state where it has been warmed up.

### <Temperature Change>

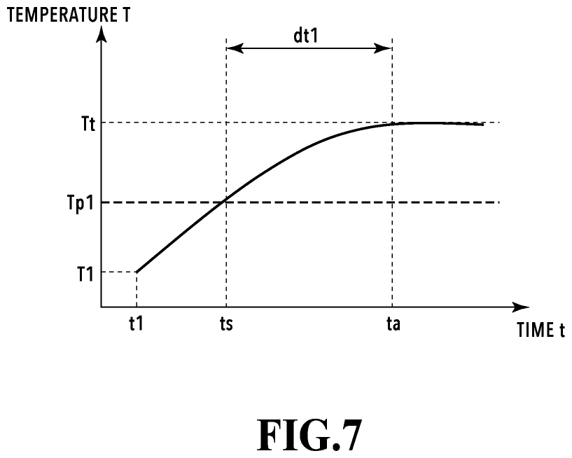

FIG. 7 is a graph illustrating an example of the temperature change of the heating device 16 in a case of starting heating from a relatively low temperature. Specifically, the graph illustrates an example of the temperature change of the heating device 16 in a case where the temperature T1 of the heating device 16 obtained in S603 described above is less than the permission temperature Tp1.

The solid line in the graph represents the temperature change of the heating device 16. The reference sign Tt in the graph represents the target temperature of the heating device 16. The reference sign ta in the graph represents a time at which the heating device 16 reaches the target temperature Tt (target temperature reaching time). The reference sign ts in the graph represents the time at which printing is started in a case where the printing mode is the 8-pass mode. This print start time ts is set according to the target temperature reaching time ta and a conveyance time dt1 required to convey the print medium 12 to the heating device 16 from the printing part (ejection part) in the 8-pass mode. The conveyance time dt1 is calculated according to the conveyance speed of the print medium 12 in the 8-pass mode and the distance from the printing part (ejection part) to the heating device 16. The permission temperature Tp1 is the temperature of the heating device 16 at the print start time ts. For example, in a case where the permission temperature table is the one illustrated in Table 1, the target temperature Tt is 70° C., and the printing mode is the 8-pass mode, the permission temperature Tp1 is set to 55° C. The permission temperature Tp1 is set in advance based on information obtained from the conveyance time dt1 and the like according to the combination of the target temperature and the printing mode, as illustrated in Table 1.

In a case where the temperature T1 obtained as a temperature at which the heating device 16 starts heating is less than the permission temperature Tp1 set in advance from the permission temperature table (S604: NO), the heating device 16 is activated (S605). Thus, the temperature of the heating device 16 starts rising at a time t1 and then approaches the permission temperature Tp1. In a case where the temperature of the heating device 16 reaches the permission temperature Tp1 (S607: YES), the control process is terminated, and the printing on the print medium 12 is started. This printing on the print medium 12 includes temperature adjustment or cleaning operation, such as wiping the head orifice face, for maintaining a normal ejection state, detection of the ejection state, operation of the carriage 13 (FIG. 1), or the like.

In response to the start of the printing on the print medium 12, the inks and the reaction liquid are ejected onto the first unit region 50 (FIG. 5) of the print medium 12 disposed as the printing part (ejection part). Also, the heating by the heating device 16 is continued even after the start of the printing on the print medium 12. Thus, the temperature of the heating device 16 rises toward the target temperature Tt from the permission temperature Tp1.

As the conveyance time dt1 elapses from the print start time ts, the first unit region 50 (FIG. 5) of the print medium 12 having undergone the printing at the printing part (ejection part) reaches the heating device 16. At this moment, the temperature of the heating device 16 reaches the target temperature Tt. This is because the print start time ts at the permission temperature Tp1 is set according to the target temperature reaching time ta and the conveyance time dt1 required to convey the print medium 12 to the heating device 16 from the printing part.

As described above, the printing is started at the print start time ts, at which the permission temperature Tp1 is reached. Thus, the target temperature Tt is reached by the time at which the unit region 50 of the print medium 12 reaches the heating device 16 (ts+dt1). Accordingly, it is possible to prevent defective drying of the image. Also, the timing to start the printing can be set to be earlier than in a case of starting the printing after the heating device 16 reaches the target temperature Tt. Note that the print start timing does not necessarily need to be the same as the print start time ts, at which the permission temperature Tp1 is reached. The printing on the print medium 12 may be started before the target temperature Tt is reached after the permission temperature Tp1 is reached. Slightly delaying the print start timing from the print start time ts instead of synchronizing them with each other makes it possible for the temperature of the heating device 16 to more reliably reach the target temperature Tt before the unit region 50 of the print medium 12 reaches the heating device 16.

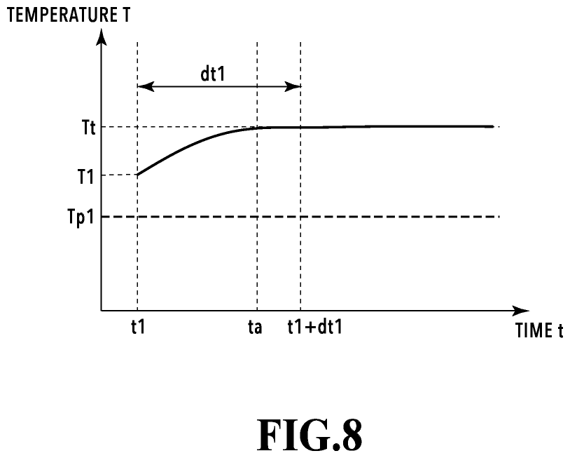

FIG. 8 is a graph illustrating an example of the temperature change of the heating device 16 in a case of starting heating from a relatively high temperature. Specifically, the graph illustrates an example of the temperature change of the heating device 16 in a case where the temperature T1 of the heating device 16 obtained in S603 described above is more than or equal to the permission temperature Tp1.

In a case where the temperature T1 obtained as a temperature at which the heating device 16 starts heating is more than or equal to the permission temperature Tp1 set in advance from the permission temperature table (S604: YES), the control process is terminated, and the printing on the print medium 12 is started. In this case, for example, the inkjet printing apparatus 10 is in a standby mode to which it transitions between printing operations, and the heating device 16 has already been activated and warmed up. Thus, the temperature T1 of the heating device 16 has already reached the target temperature Tt by a time t1+dt1 at which the unit region 50 of the print medium 12 reaches the heating device 16. Accordingly, it is possible to prevent defective drying of the image. Also, the print start timing can be set at an even earlier time than that in the case where the obtained temperature T1 is less than the permission temperature Tp1 (FIG. 7). This is because the permission temperature Tp1 and the print start timing may be determined without having to heat the heating device 16 and wait for its temperature to rise or obtain the rate of temperature rise.

As described above, according to the present embodiment, it is possible to shorten the time required before starting printing after accepting a print instruction. For example, the inkjet printing apparatus 10 obtains the permission temperature Tp1 from the ROM 202 in which information indicating the permission temperature has been stored in advance. In response to the temperature of the heating device 16 reaching this permission temperature Tp1, the inkjet printing apparatus 10 starts conveying the print medium 12 onto which the inks and the reaction liquid have been ejected. In this way, it is possible to appropriately hasten the print start timing without requiring complicated calculation for predicting the rise in the temperature of the heating device 16 or requiring a wait time before obtaining data for calculation.

### Second Embodiment

In a second embodiment, a description will be given mainly of its difference from the first embodiment. The apparatus configuration of the inkjet printing apparatus 10, the ink compositions, and the like to be used are the same as those in the first embodiment, and description thereof will therefore be omitted.

### <Multi-Pass Printing>

In the first embodiment, images are printed on the print medium 12 in an 8-pass mode. In the present embodiment, images are printed on the print medium 12 in an 8-pass mode or a 16-pass mode. In the 16-pass mode, the amount of conveyance of the print medium 12 per scan of the print head 11 is half of that in the 8-pass mode. In this case, the conveyance speed of the print medium 12 decreases, thus increasing the time required to convey the unit region 50 (FIG. 5) to the heating device 16. Accordingly, in the 16-pass mode, printing may be started with earlier timing than in the 8-pass mode.

### <Permission Temperature Table>

In the present embodiment, the permission temperature table stores permission temperatures associated respectively with a plurality of target temperatures for each number of passes. The number of passes is the number of times the print head 11 is scanned over a unit region 50. An example of the permission temperature table in the present embodiment is illustrated in Table 2 below.

TABLE 2

| Number of | Permission | Target Temperature Setting (° C.) | | |
|---|---|---|---|---|
| Passes | Temperature (° C.) | 70 | 80 | 90 |
| 8 | Tp1 | 55 | 65 | 75 |
| 16 | Tp2 | 50 | 60 | 70 |

In the example of Table 2, permission temperatures Tp1 or printing an image on the print medium 12 in the 8-pass mode at an environmental temperature of 25° C. are set in advance. Also, permission temperatures Tp2 for printing an image on the print medium 12 in the 16-pass mode at an environmental temperature of 25° C. are set in advance. Incidentally, in the present embodiment too, the same polyvinyl chloride sheet as that in the first embodiment is used as the print medium 12.

Specifically, the permission temperatures Tp1 for the case where the number of passes is eight (8-pass mode) are set to be the same as those in Table 1. Also, the permission temperatures Tp2 for the case where the number of passes is 16 (16-pass mode) are set as below. Specifically, in a case where the target temperature is 70° C., the permission temperature Tp2 is set to 50° C. Also, in a case where the target temperature is 80° C., which is higher than 70° C., the permission temperature Tp2 is set to 60° C., which is higher than 50° C. Also, in a case where the target temperature is 90° C., which is higher than 80° C., the permission temperature Tp2 is set to 70° C., which is higher than 60° C. Also, in a case where the target temperature is any one of 70° C., 80° C., and 90° C., the permission temperature Tp2 for the case where the number of passes is 16 is lower than the permission temperature Tp1 for the case where the number of passes is 8, which is smaller than 16.

### <Control Process>

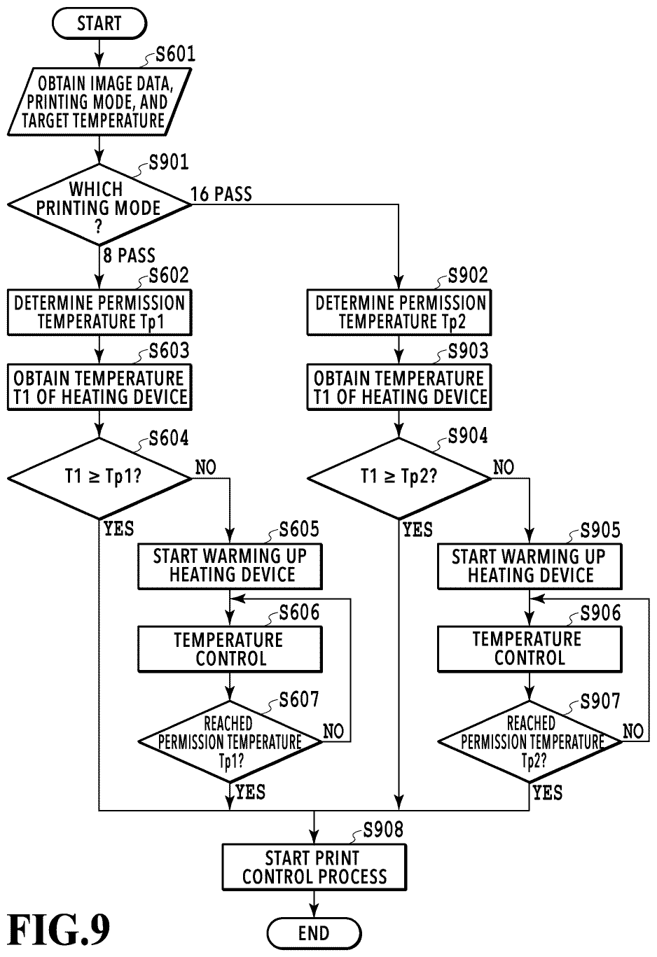

Next, a flow of a control process in the present embodiment will be described. FIG. 9 is a flowchart illustrating an example of a series of processes (control process) executed in the present embodiment. The CPU 201 (FIG. 2) implements the series of processes (control process) illustrated in FIG. 9 by reading out a program stored in the ROM 202 (FIG. 2) or the like to the RAM 203 (FIG. 2) and executing it.

In the present embodiment, the processes of S901 to S907 are newly added to the control process in the first embodiment illustrated in FIG. 6. Also, in the present embodiment, the process of S608 is replaced with the process of S908. In the present embodiment, the processing proceeds to S901 after S601.

In S901, the CPU 201 judges whether the printing mode is the 8-pass mode or the 16-pass mode based on the printing mode information obtained in S601. If it is judged that the printing mode is the 8-pass mode, the processing proceeds to S602. On the other hand, if it is judged that the printing mode is the 16-pass mode, the processing proceeds to S902.

In S902, the CPU 201 determines the permission temperature Tp2 based on the target temperature information obtained in S601 and the permission temperature table stored in the ROM 202. After determining the permission temperature Tp2, the processing proceeds to S903.

In S903, the CPU 201 obtains the temperature T1 of the heating device 16 using the temperature sensor 28. After obtaining the temperature of the heating device 16 in S903, the processing proceeds to S904.

In S904, the CPU 201 compares the temperature T1 of the heating device 16 obtained in S903 and the permission temperature Tp2 determined in S902 with each other. If the temperature T1 of the heating device 16 is more than or equal to the permission temperature Tp2, the processing proceeds to S908. If the temperature T1 of the heating device 16 is less than the permission temperature Tp2, the processing proceeds to S905.

In S905, the CPU 201 activates the heating device 16 to start warming up the heating device 16. After activating the heating device 16 in S905, the processing proceeds to S906. In S906, the CPU 201 starts temperature control on the heating device 16. After starting the temperature control on the heating device 16, the processing proceeds to S907.

In S907, the CPU 201 judges whether the temperature T1 of the heating device 16 has reached the permission temperature Tp2. If the temperature T1 of the heating device 16 has not reached the permission temperature Tp2, the processing returns to S906. If the temperature T1 of the heating device 16 has reached the permission temperature Tp2, the processing proceeds to S908.

In S908, the CPU 201 starts executing a print control process based on a print signal obtained from the image data obtained in S601, thereby causing the inkjet printing apparatus 10 to start a printing operation and a conveyance operation. This starts printing with the inks and the reaction liquid on the print medium 12 disposed at the printing part (ejection part) and also starts conveyance of the print medium 12 to which the inks and the reaction liquid have been applied. Note that, in the case where the processing proceeds to S908 from S607, the temperature control of the heating device 16 is performed from the permission temperature Tp1 in the print control process. Also, in the case where the processing proceeds to S908 from S907, the temperature control of the heating device 16 is performed from the permission temperature Tp2 in the print control process. On the other hand, in the case where the processing proceeds to S908 from S604 or S904, the heating device 16 has already been activated and warmed up. For this reason, in the print control process, the temperature control of the heating device 16 is performed from the state where it has been warmed up.

### <Temperature Change>

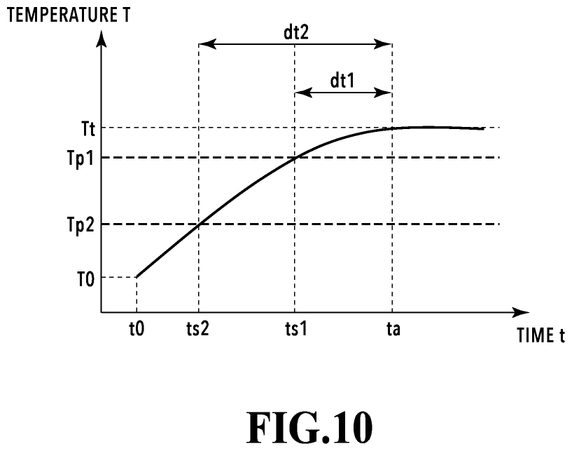

FIG. 10 is a graph illustrating an example of the temperature change of the heating device 16 in the present embodiment. The solid line in the graph represents the temperature change of the heating device 16 from a time to. Reference sign T0 in the graph represents the temperature of the heating device 16 at the time t0. Reference sign ts1 in the graph represents the print start time in the case where the printing mode is the 8-pass mode, and corresponds to the print start time ts in FIG. 7. Reference sign ts2 in the graph represents the print start time in the case where the printing mode is the 16-pass mode. This print start time ts2 is set according to the target temperature reaching time ta and a conveyance time dt2 required to convey the print medium 12 to the heating device 16 from the printing part (ejection part) in the 16-pass mode. The conveyance time dt2 is calculated according to the conveyance speed of the print medium 12 in the 16-pass mode and the distance from the printing part (ejection part) to the heating device 16. The permission temperature Tp2 is the temperature of the heating device 16 at the print start time ts2. The permission temperature Tp2 is set in advance based on information obtained from the conveyance time dt2 and the like according to the combination of the target temperature and the printing mode, as illustrated in Table 2.

As described earlier, the amount and speed of conveyance of the print medium 12 in the 16-pass mode are lower than the amount and speed of conveyance of the print medium 12 in the 8-pass mode. Thus, the permission temperature Tp2 for the 16-pass mode is lower than the permission temperature Tp1 for the 8-pass mode. Accordingly, if the temperature of the heating device 16 from which the heating device 16 starts heating is the same for the 16-pass mode and the 8-pass mode, the timing to start the printing (conveyance) on the print medium 12 will be earlier for the 16-pass mode than for the 8-pass mode. That is, if the temperature of the heating device 16 from which the heating device 16 starts heating is the same, then, the larger the number of passes, the earlier the print start timing can be.

Note that, in the present embodiment, a description has been given of an example in which the permission temperature is varied according to the conveyance speed of the print medium 12 that is based on the number of passes for the printing mode, but the present embodiment is not limited to this. The permission temperature may be varied according to the conveyance speed of the print medium 12 that is based on another factor. For example, a permission temperature table as illustrated in Table 2 may be set in a case where the scan speed of the print head 11 is different, a wait time is set between scans, a recovery operation is performed before printing, or in another similar case. Varying the permission temperature according to the scan speed, the wait time, or the duration of the recovery operation can appropriately hasten the print start timing.

### Third Embodiment

In a third embodiment, a description will be given mainly of its difference from the first embodiment, as in the second embodiment. The apparatus configuration of the printing apparatus and the ink compositions to be used are the same as those in the first embodiment, and description thereof will therefore be omitted. In the present embodiment, the print medium 12 may be a polyethylene terephthalate (PET) film having a smaller heat capacity than that of the polyvinyl chloride sheet in the first and second embodiments. This PET film is a 75 m-thick film with the trade name “Graphical Indoor Ultra Clear PET with Adhesive Gloss GIY-0305” manufactured by LINTEC SIGN SYSTEM, INC. In the following, the above polyvinyl chloride sheet will also be referred to “PVC sheet.”

### <Permission Temperature Table>

In the present embodiment, a permission temperature is specified in advance according to the heat capacity of the print medium 12. A permission temperature table stores permission temperatures associated respectively with a plurality of heat capacities. In the permission temperature table, the larger the heat capacity, the higher the permission temperature is set. An example of the permission temperature table is illustrated in Table 3 below.

TABLE 3

| Heat | Permission | Target Temperature Setting (° C.) | | |
|---|---|---|---|---|
| Capacity | Temperature (° C.) | 70 | 80 | 90 |
| Large | Tp1 | 55 | 65 | 75 |
| Small | Tp3 | 52 | 61 | 70 |

In the example of Table 3, permission temperatures Tp1 for printing an image on a PVC sheet, or a print medium 12 with large heat capacity, in the 8-pass mode at an environmental temperature of 25° C. are set in advance. Also, permission temperatures Tp3 for printing an image on a PET film, or a print medium 12 with small heat capacity, in the 8-pass mode at an environmental temperature of 25° C. are set in advance.

In the example of the Table 3 presented above, the permission temperatures Tp1 for the print medium 12 with large heat capacity (“Large”) are set to be the same as those in Table 1 presented earlier. The permission temperatures Tp3 for the print medium 12 with small heat capacity (“Small”) are set as below. Specifically, in a case where the target temperature is 70° C., the permission temperature Tp3 is set to 52° C. Also, in a case where the target temperature is 80° C., which is higher than 70° C., the permission temperature Tp3 is set to 61° C., which is higher than 52° C. Also, in a case where the target temperature is 90° C., which is higher than 80° C., the permission temperature Tp3 is set to 70° C., which is higher than 61° C. Also, in a case where the target temperature is any one of 70° C., 80° C., and 90° C., the permission temperature Tp1 for the print medium 12 with large heat capacity is higher than the permission temperature Tp3 for the print medium 12 with small heat capacity.

### <Control Process>

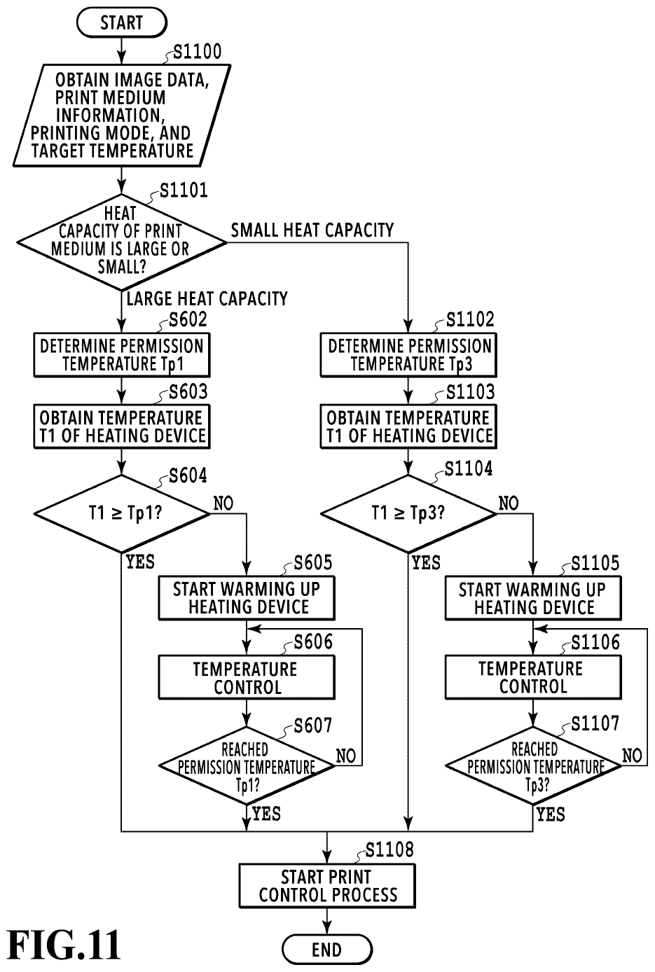

Next, a flow of a control process in the present embodiment will be described. FIG. 11 is a flowchart illustrating an example of a series of processes (control process) executed in the present embodiment. The CPU 201 (FIG. 2) implements the series of processes (control process) illustrated in FIG. 11 by reading out a program stored in the ROM 202 (FIG. 2) or the like to the RAM 203 (FIG. 2) and executing it.

In the present embodiment, the processes of S1101 to S1107 are newly added to the control process in the first embodiment illustrated in FIG. 6. Also, in the present embodiment, the process of S601 is replaced with the process of S1100, and the process of S608 is replaced with the process of S1108.

In S1100, the CPU 201 obtains image data, printing mode information, and target temperature information, as in S601, and also obtains print medium information indicating the thickness, type, and the like of the print medium 12. The print medium information is, for example, designated (selected) by the user using the display operation unit 21 and supplied from the display operation unit 21 in accordance with that designation (selection). After obtaining all of the image data, the printing mode information, the target temperature information, and the print medium information, the processing proceeds to S1101.

In S1101, the CPU 201 classifies the heat capacity of the print medium 12 based on the print medium information obtained in S601. For example, the CPU 201 classifies a print medium 12 with a thickness of 100 μm or more as a print medium with large heat capacity. Also, the CPU 201 classifies a print medium 12 with a thickness of less than 100 μm as a print medium 12 with small heat capacity. If the print medium 12 is classified as one with large heat capacity, the processing proceeds to S602. On the other hand, if the print medium 12 is classified as one with small heat capacity, the processing proceeds to S1102.

In S1102, the CPU 201 determines the permission temperature Tp3 based on the target temperature information obtained in S1101 and the permission temperature table stored in the ROM 202. After determining the permission temperature Tp3, the processing proceeds to S1103.

In S1103, the CPU 201 obtains the temperature T1 of the heating device 16 using the temperature sensor 28. After obtaining the temperature of the heating device 16 in S1103, the processing proceeds to S1104.

In S1104, the CPU 201 compares the temperature T1 of the heating device 16 obtained in S1103 and the permission temperature Tp3 determined in S1102 with each other. If the temperature T1 of the heating device 16 is more than or equal to the permission temperature Tp3, the processing proceeds to S1108. If the temperature T1 of the heating device 16 is less than the permission temperature Tp3, the processing proceeds to S1105.

In S1105, the CPU 201 activates the heating device 16 to start warming up the heating device 16. After activating the heating device 16 in S1105, the processing proceeds to S1106. In S1106, the CPU 201 starts temperature control on the heating device 16. After starting the temperature control on the heating device 16, the processing proceeds to S1107.

In S1107, the CPU 201 judges whether the temperature T1 of the heating device 16 has reached the permission temperature Tp3. If the temperature T1 of the heating device 16 has not reached the permission temperature Tp3, the processing returns to S1106. If the temperature T1 of the heating device 16 has reached the permission temperature Tp3, the processing proceeds to S1108.

In S1108, the CPU 201 starts executing a print control process based on a print signal obtained from the image data obtained in S1100, thereby causing the inkjet printing apparatus 10 to start a printing operation and a conveyance operation. This starts printing with the inks and the reaction liquid on the print medium 12 disposed at the printing part (ejection part) and also starts conveyance of the print medium 12 to which the inks and the reaction liquid have been applied. Note that, in the case where the processing proceeds to S1108 from S607, the temperature control of the heating device 16 is performed from the permission temperature Tp1 in the print control process. Also, in the case where the processing proceeds to S1108 from S1107, the temperature control of the heating device 16 is performed from the permission temperature Tp3 in the print control process. On the other hand, in the case where the processing proceeds to S1108 from S604 or S1104, the heating device 16 has already been activated and warmed up. For this reason, in the print control process, the temperature control of the heating device 16 is performed from the state where it has been warmed up.

### <Temperature Change>

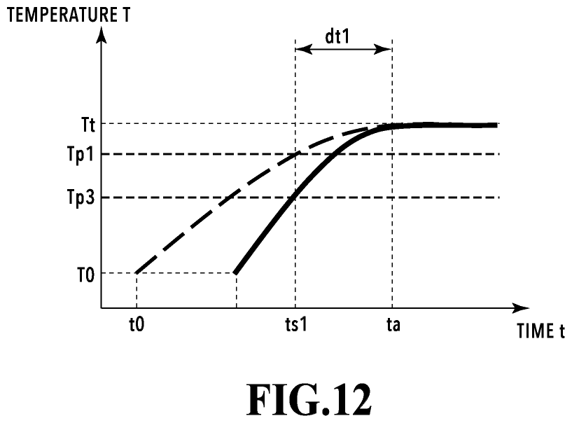

FIG. 12 is a graph illustrating an example of the temperature change of the heating device 16 in the present embodiment. The solid line in the graph represents the temperature change of the heating device 16 in a case of performing printing on a print medium 12 with small heat capacity. The dotted line in the graph represents the temperature change of the heating device 16 in a case of performing printing on a print medium 12 with large heat capacity.

The print medium 12 with small heat capacity has such a temperature characteristic that its temperature rises more quickly than the print medium 12 with large heat capacity. In the present embodiment, the permission temperature Tp3 for the print medium 12 with small heat capacity is lower than the permission temperature Tp1 for the print medium 12 with large heat capacity. Thus, the smaller the heat capacity, the earlier the print start timing can be.

Note that, in the present embodiment, the CPU 201 classifies the heat capacity of the print medium 12 based on the thickness of the print medium 12, but the classification is not limited to this. For example, the CPU 201 may classify the heat capacity of the print medium 12 based on the material of the print medium 12. Alternatively, the CPU 201 may classify the heat capacity of the print medium 12 based on the layer structure of the print medium 12. Alternatively, the CPU 201 may classify the heat capacity of the print medium 12 based on a combination of at least two of the thickness, material, and layer structure of the print medium 12. Alternatively, the CPU 201 may classify the heat capacity of the print medium 12 based on a content designated by a user operation on the display operation unit 21 by the user. Alternatively, the CPU 201 may classify the heat capacity of the print medium 12 by checking the print medium information against a database prepared in advance.

### Fourth Embodiment

In a fourth embodiment, a description will be given mainly of its difference from the first embodiment, as in the second embodiment. In the present embodiment, the environmental temperature sensor 29 connected to the control unit 20 is used. The other features of the apparatus configuration of the printing apparatus and the ink compositions to be used are the same as those in the first embodiment, and description thereof will therefore be omitted.

### <Permission Temperature Table>

In the present embodiment, a permission temperature is specified in advance according to the environmental temperature around the print medium 12. A permission temperature table stores permission temperatures associated respectively with a plurality of environmental temperatures. In the permission temperature table, the higher the environmental temperature, the lower the permission temperature is set. An example of the permission temperature table is illustrated in Table 4 below.

TABLE 4

| Environmental | Permission | Target Temperature Setting (° C.) | | |
|---|---|---|---|---|
| Temperature | Temperature (° C.) | 70 | 80 | 90 |
| 25° C. | Tp1 | 55 | 65 | 75 |
| 30° C. | Tp4 | 54 | 63 | 72 |

In the example of Table 4 presented above, permission temperatures Tp1 for printing an image on the print medium 12 in an 8-pass mode at an environmental temperature of 25° C. are set in advance. Also, permission temperatures Tp4 for printing an image on the print medium 12 in the 8-pass mode at an environmental temperature of 30° C. are set in advance. Note that the print medium 12 used in the present embodiment is the PVC sheet used in the first to third embodiments.

In the example of Table 4 presented above, the permission temperatures Tp1 for an environmental temperature of 25° C. are set to be the same as those in Table 1 presented earlier. The permission temperature Tp4 for an environmental temperature of 30° C. are set as below. Specifically, in a case where the target temperature is 70° C., the permission temperature Tp4 is set to 54° C. Also, in a case where the target temperature is 80° C., which is higher than 70° C., the permission temperature Tp4 is set to 63° C., which is higher than 54° C. Also, in a case where the target temperature is 90° C., which is higher than 80° C., the permission temperature Tp4 is set to 72° C., which is higher than 63° C. Also, in a case where the target temperature is any one of 70° C., 80° C., and 90° C., the permission temperature Tp4 for an environmental temperature of 30° C. is lower than the permission temperature Tp1 for an environmental temperature pf 25° C.

### <Control Process>

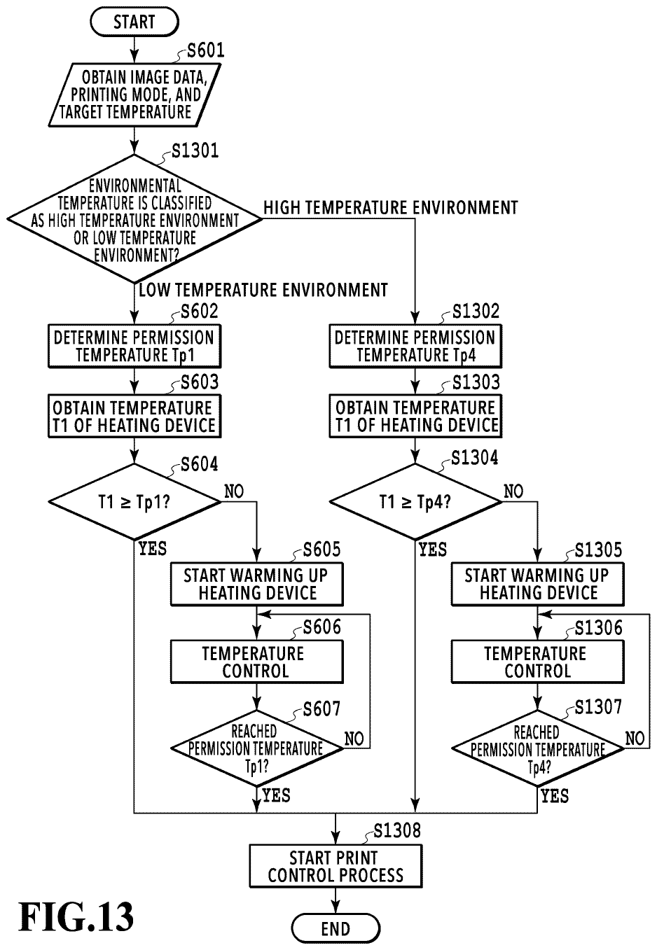

Next, a flow of a control process in the present embodiment will be described. FIG. 13 is a flowchart illustrating an example of a series of processes (control process) executed in the present embodiment. The CPU 201 (FIG. 2) implements the series of processes (control process) illustrated in FIG. 13 by reading out a program stored in the ROM 202 (FIG. 2) or the like to the RAM 203 (FIG. 2) and executing it.

In the present embodiment, the processes of S1301 to S1307 are newly added to the control process in the first embodiment illustrated in FIG. 6. Also, in the present embodiment, the process of S608 is replaced with the process of S1308. In the present embodiment, the processing proceeds to S1301 after S601.

In S1301, the CPU 201 obtains the environmental temperature using the environmental temperature sensor. In S1301, the CPU 201 obtains the environmental temperature using the environmental temperature sensor, and classifies the obtained environmental temperature as “high temperature environment” or “low temperature environment.” For example, in a case where the obtained environmental temperature is higher than 25° C., the CPU 201 classifies it as “high temperature environment.” On the other hand, in a case where the obtained environmental temperature is lower than or equal to 25° C., the CPU 201 classifies it as “low temperature environment.” If the obtained environmental temperature is classified as “low temperature environment,” the processing proceeds to S602. On the other hand, if the obtained environmental temperature is classified as “high temperature environment,” the processing proceeds to S1302.

In S1302, the CPU 201 determines the permission temperature Tp4 based on the target temperature information obtained in S601 and the permission temperature table stored in the ROM 202. After determining the permission temperature Tp4, the processing proceeds to S1303.

In S1303, the CPU 201 obtains the temperature T1 of the heating device 16 using the temperature sensor 28. After obtaining the temperature of the heating device 16 in S1303, the processing proceeds to S1304.

In S1304, the CPU 201 compares the temperature T1 of the heating device 16 obtained in S1303 and the permission temperature Tp4 determined in S1302 with each other. If the temperature T1 of the heating device 16 is more than or equal to the permission temperature Tp4, the processing proceeds to S1308. If the temperature T1 of the heating device 16 is less than the permission temperature Tp4, the processing proceeds to S1305.

In S1305, the CPU 201 activates the heating device 16 to start warming up the heating device 16. After activating the heating device 16 in S1305, the processing proceeds to S1306. In S1306, the CPU 201 starts temperature control on the heating device 16. After starting the temperature control on the heating device 16, the processing proceeds to S1307.

In S1307, the CPU 201 judges whether the temperature T1 of the heating device 16 has reached the permission temperature Tp4. If the temperature T1 of the heating device 16 has not reached the permission temperature Tp4, the processing returns to S1306. If the temperature T1 of the heating device 16 has reached the permission temperature Tp4, the processing proceeds to S1308.

In S1308, the CPU 201 starts executing a print control process based on a print signal obtained from the image data obtained in S601, thereby causing the inkjet printing apparatus 10 to start a printing operation and a conveyance operation. This starts printing with the inks and the reaction liquid on the print medium 12 disposed at the printing part (ejection part) and also starts conveyance of the print medium 12 to which the inks and the reaction liquid have been applied. Note that, in the case where the processing proceeds to S1308 from S607, the temperature control of the heating device 16 is performed from the permission temperature Tp1 in the print control process. Also, in the case where the processing proceeds to S1308 from S1307, the temperature control of the heating device 16 is performed from the permission temperature Tp4 in the print control process. On the other hand, in the case where the processing proceeds to S1308 from S604 or S1304, the heating device 16 has already been activated and warmed up. For this reason, in the print control process, the temperature control of the heating device 16 is performed from the state where it has been warmed up.

### <Temperature Change>

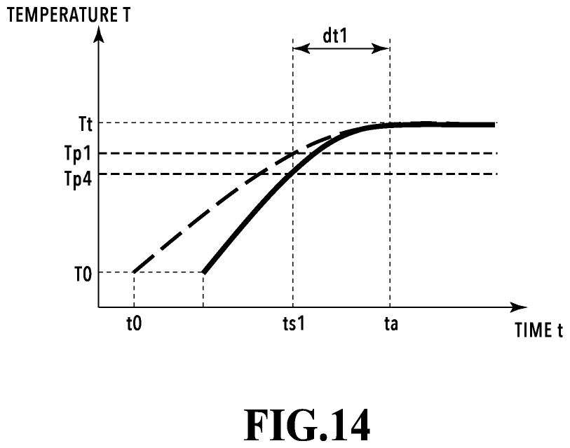

FIG. 14 is a graph illustrating an example of the temperature change of the heating device 16 in the present embodiment. The solid line in the graph represents the temperature change of the heating device 16 in a case where the environmental temperature is 30° C. The dotted line in the graph represents the temperature change of the heating device 16 in a case where the environmental temperature is 25° C.

With “high temperature environment,” the heat dissipation from the heating device 16 to the external environment is small. Thus, with “high temperature environment,” the print medium 12 has such a temperature characteristic that its temperature rises more quickly than with “low temperature environment.” In the present embodiment, the permission temperature Tp4 for “high temperature environment” is lower than the permission temperature Tp1 for “low temperature environment.” Thus, the higher the environmental temperature, the earlier the print start timing can be.

### OTHER EMBODIMENTS

In the above-described embodiments, examples with the inkjet printing apparatus 10 that performs multi-pass printing have been described. However, the present disclosure is not limited to a particular printing apparatus as long as it performs printing through scanning relative to the print medium 12. For example, the present disclosure may be a line head-type printing apparatus with a fixed print head 11. This printing apparatus includes, for example, a line head with a width that is greater than or equal to the width of the print medium 12. The print medium 12 is conveyed in a direction intersecting the width direction of this line head with the line head fixed.

Also, in the above-described embodiments, cases in which the temperature of the heating device 16 is changed to change the intensity of drying of the print medium 12 have been described as examples. However, the present disclosure is not limited to these. The present disclosure is applicable to printing apparatuses including a configuration that changes the intensity of drying of the print medium 12 by means other than temperature. Examples include a case where a configuration capable of varying a factor such as the heat discharge rate of the heating device 16 is included, and the temperature change characteristic of the heating device 16 changes according to the factor. In this case, a table in which different permission temperatures are set according to the factor may be used.

Also, the temperature change characteristic may vary depending on the amount of the inks and the reaction liquid in the printing. In this case, a table may be used in which permission temperatures differing from each other according to the image data to be printed or a setting value indicating a change in the amount of the inks to be applied, such as “saturation” or “ink density,” are set. Further, in consideration of a case where the drying rate may vary depending on the environmental humidity, a table may be used in which permission temperatures differing from each other according to the environmental humidity are set.

Also, in the above-described embodiments, printing on the print medium 12 is started at a timing at which the temperature T1 of the heating device 16 reaches a permission temperature, but the present disclosure is not limited to this. For example, a wait time may be provided for which the printing apparatus waits after the temperature T1 of the heating device 16 reaches the permission temperature. This is because it is possible that a print image desired by the user cannot be obtained due to factors such as the settings of the printing mode to be used, the type of the print medium 12, the environmental temperature, the environmental humidity, and the like. In a case where a wait time is provided, the printing operation and the conveyance operation are started after the elapse of the wait time after the temperature T1 of the heating device 16 reaches the permission temperature. In this way, the image desired by the user can be obtained. This wait time may be designated by the user, for example. Alternatively, this wait time may be automatically set according to the printing mode, the type of the print medium 12, the environmental temperature, the environmental humidity, and the like.

In the above-described embodiments, the storage device storing information indicating permission temperatures are the ROM 202, but is not limited to this. For example, the storage device storing the information indicating permission temperatures may be a memory included in the external apparatus 200 (FIG. 2). Alternatively, in a case where an information processing apparatus such as an information management server is connected to the inkjet printing apparatus 10 through a network such as the Internet, the storage device storing the information indicating permission temperatures may be a memory included in the information processing apparatus.

In the above-described embodiments, the CPU 201, which executes programs, is employed as an obtaining unit which obtains a permission temperature from the storage device, but the obtaining unit is not limited to this. For example, hardware such as an ASIC or an electronic circuit that implements one or more functions may be employed as the obtaining unit.

In the above-described embodiments, the sub scanning motor 260 is employed as a conveyance unit which conveys the print medium, but the conveyance unit is not limited to this. For example, hardware such as the rollers to be driven by the sub scanning motor 260 may be included as the conveyance unit which conveys the print medium.

In the above-described embodiments, the CPU 201, which executes programs, is employed as a conveyance control unit which controls the conveyance unit, but the conveyance control unit is not limited to this. For example, hardware such as an ASIC or an electronic circuit that implements one or more functions may be employed as the conveyance control unit. Also, the sub scanning motor driver 26 may be included as the conveyance control unit.

In the above-described embodiments, the print head 11 is employed as a printing unit which performs printing on the print medium 12, but the printing unit is not limited to this. For example, the motor for scanning the print head 11 may be included as the printing unit.

In the above-described embodiments, the CPU 201, which executes programs, is employed as a printing control unit which controls the printing unit, but the printing control unit is not limited to this. For example, hardware, such as an ASIC or an electronic circuit, that implements one or more functions may be employed as the printing control unit. Also, the print head driver 27 may be included as the printing control unit.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to an aspect of the present disclosure, it is possible to shorten the time required before starting printing after accepting a print instruction.

This application claims the benefit of Japanese Patent Application No. 2024-220850, filed Dec. 17, 2024, which is hereby incorporated by reference herein in its entirety.

What is claimed is:

1. A printing apparatus comprising:
a conveyance unit configured to convey a print medium;
a heating device disposed on a path along which the print medium is conveyed by the conveyance unit, and configured to heat a liquid applied to the print medium;
a printing unit configured to perform printing on the print medium;
one or more memories; and
one or more processors configured to function to
obtain a permission temperature being a temperature at which printing on the print medium is permitted to start from a storage device storing information indicating the permission temperature, and
control the printing unit such that the printing unit starts printing on the print medium in a case where a temperature of the heating device reaches the permission temperature, wherein
the permission temperature is set to be lower than a target temperature specified to fix the liquid applied to the print medium to the print medium.

2. The printing apparatus according to claim 1, wherein the controlling the printing unit such that the printing unit starts printing on the print medium includes conveying the print medium to the printing unit with the conveyance unit.

3. The printing apparatus according to claim 1, wherein the heating device is located downstream of the printing unit in a conveyance direction of the print medium.

4. The printing apparatus according to claim 1, wherein the permission temperature is set based on a time required to convey the print medium to the heating device from the printing unit.

5. The printing apparatus according to claim 1, wherein in a case where a wait time for which the printing apparatus waits after the temperature of the heating device reaches the permission temperature is set, the processor controls the printing unit such that the printing unit starts printing on the print medium after elapse of the wait time after the temperature of the heating device reaches the permission temperature.

6. The printing apparatus according to claim 1, wherein
the information includes the permission temperatures that differ from each other according to the target temperature, and
the permission temperature in a case where the target temperature is a first target temperature is higher than the permission temperature in a case where the target temperature is a second target temperature lower than the first target temperature.

7. The printing apparatus according to claim 1, wherein
the information includes the permission temperatures that differ from each other according to the number of scans over a unit region of the print medium, and
the permission temperature in a case where the number of scans is a first number of scans is lower than the permission temperature in a case where the number of scans is a second number of scans smaller than the first number of scans.

8. The printing apparatus according to claim 1, wherein
the information includes the permission temperatures that differ from each other according to heat capacity of the print medium, and
the permission temperature in a case where the heat capacity is a first heat capacity is higher than the permission temperature in a case where the heat capacity is a second heat capacity smaller than the first heat capacity.

9. The printing apparatus according to claim 1, wherein
the information includes the permission temperatures that differ from each other according to an environmental temperature indicating a temperature of an environment in which the printing apparatus operates, and
the permission temperature in a case where the environmental temperature is a first environmental temperature is lower than the permission temperature in a case where the environmental temperature is a second environmental temperature lower than the first environmental temperature.

10. A printing method of a printing apparatus including
a conveyance unit configured to convey a print medium,
a heating device disposed on a path along which the print medium is conveyed by the conveyance unit, and configured to heat a liquid applied to the print medium, and
a printing unit configured to perform printing on the print medium,
the printing method comprising:
obtaining a permission temperature being a temperature at which printing on the print medium is permitted to start from a storage device storing information indicating the permission temperature; and
controlling the printing unit such that the printing unit starts printing on the print medium in a case where an obtained temperature of the heating device reaches the permission temperature, wherein
the permission temperature is set to be lower than a target temperature specified to fix the liquid applied to the print medium to the print medium.
